(19) United States
(12) Patent Application Publication
(10) Pub. No.: US 2014/0191558 A1
(43) Pub. Date: Jul. 10, 2014

(54) OPERATOR PANEL FOR A MACHINE

(71) Applicant: CATERPILLAR INC., Peoria, IL (US)

(72) Inventors: Robert E. Riedel, JR., Peoria, IL (US); Daniel J. Whiting, JR., Normal, IL (US); Anthony S. Cooksey, Metamora, IL (US)

(73) Assignee: Caterpillar Inc., Peoria, IL (US)

(21) Appl. No.: 13/736,193

(22) Filed: Jan. 8, 2013

(51) Int. Cl. G05G 1/01; F16H 59/04; B60P 1/04; B60K 20/08

(52) U.S. Cl. CPC G05G 1/01; B60K 20/08; F16H 59/044; B60P 1/04
USPC 298/19 R; 180/336

(57) ABSTRACT

A control panel provided within an operator cabin of a machine is disclosed. A transmission input device disposed on the control panel. The transmission input device is operable to select from a plurality of transmission modes of the machine. More specifically, the transmission input device includes a rotary switch. Further, a hoisting input device is disposed on the control panel. The hoisting input device is operable to select from a plurality of hoisting functions associated with a payload carrier of the machine.

### TECHNICAL FIELD

The present disclosure relates to an operator panel for a machine. More particularly, the present disclosure relates to the operator panel for controlling transmission and hoisting functions of the machine.

### BACKGROUND

Machines having a payload carrier include input devices to control transmission of the machine and hoisting functions associated with movement of the payload carrier of the machine. Operators of such machines may sometimes need to control both the transmission and hoisting functions concurrently, for example, during a dump cycle of the machine.

Conventionally, separate input devices, typically in the form of levers, are used to independently control the transmission and the hoisting functions of the machine. A first lever may allow the operator to set transmission settings and gear transmission settings for the machine. A second lever may allow the operator to control a plurality of actuators in order to raise, lower, hold or float the payload carrier of the machine.

However, such separate levers are expensive and may require additional space within an operator station of the machine. Moreover, operating separate levers to simultaneously control the transmission and hoisting functions may require the operator to constantly switch hands between the separate controls. This may result in difficulty of operation of the separate levers.

Therefore, there is a need for an improved input device to overcome the above mentioned shortcomings.

### SUMMARY OF THE DISCLOSURE

In one aspect of the present disclosure, a control panel provided within an operator cabin of a machine is disclosed. A transmission input device is disposed on the control panel. The transmission input device is operable to select from a plurality of transmission modes of the machine. More specifically, the transmission input device includes a rotary switch. Further, a hoisting input device is disposed on the control panel. The hoisting input device is operable to select from a plurality of hoisting functions associated with a payload carrier of the machine.

In another aspect, a control panel provided within an operator cabin of a machine is disclosed. A hoisting input device is disposed on the control panel, the hoisting input device operable to select from a plurality of hoisting functions associated with a payload carrier of the machine. The hoisting input device includes a rotary switch. Additionally, a transmission input device is disposed on the control panel. The transmission input device is operable to select from a plurality of transmission modes of the machine.

In yet another aspect, a machine is disclosed. The machine includes a frame and a payload carrier pivotally attached to the frame. An actuator is coupled between the frame and the payload carrier. The actuator is configured to raise and lower the payload carrier relative to the frame. A control panel is provided within an operator cabin of the machine. A rotary switch and an input device are disposed on the control panel. One of the rotary switch and the input device is operable to select from a plurality of transmission modes of the machine. Whereas, the other of the rotary switch and the input device is operable to select from a plurality of hoisting functions associated with movement of the actuator to raise and lower the payload carrier relative to the frame of the machine.

Other features and aspects of this disclosure will be apparent from the following description and the accompanying drawings.

### BRIEF DESCRIPTION OF THE DRAWINGS

FIG. 1 is a diagrammatic view of an exemplary machine, according to an embodiment of the present disclosure;

FIG. 2 illustrates functional components of the machine for transmission and hoisting control;

FIG. 3 is a perspective view of an operator station of the machine having a control panel;

FIG. 4 is a side view illustrating operations of a roller switch disposed on the input device for the machine;

FIG. 5 is the perspective view of the operator station having a rocker switch for hoist control of the machine; and

FIG. 6 is a perspective view of the operator station of the machine having another control panel.

### DETAILED DESCRIPTION

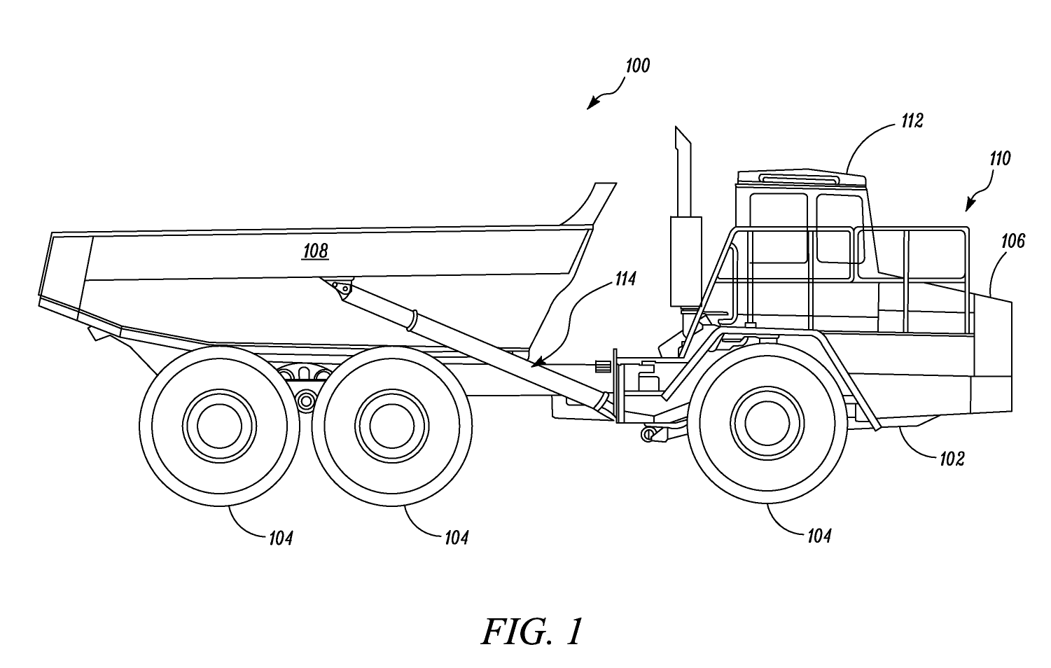

FIG. 1 illustrates an exemplary machine 100. In one embodiment, the machine 100 may embody an articulated truck. As illustrated in FIG. 1, the machine 100 may be a wheeled machine and includes a frame 102, wheels 104, an engine compartment 106 and a payload carrier 108. The machine 100 may further include an engine positioned in the engine compartment 106 and supported on the frame 102. The engine may be an internal combustion engine, for example, a petrol engine, a diesel engine, or a gas powered engine.

In the illustrated embodiment, a cab 112 is mounted on a front end 110 of the frame 102 of the machine 100. The cab 112 may be disposed above the engine and extend rearward beyond the engine. In some embodiments, the cab 112 may enclose the engine by forming a portion of the engine compartment 106. In other embodiments, the cab 112 may be pivotally mounted to the frame 102, such that the cab 112 may be tilted to provide an access to the engine.

During operation of the machine 100, the payload carrier 108 of the machine 100 may be raised or lowered with respect to the frame 102 of the machine 100 by means of an actuator 114. The actuator 114 is coupled between the frame 102 and the payload carrier 108. The actuator 114 may include lift cylinders, or any other hoisting mechanism known in the art. The present disclosure relates to a control panel 202 for controlling a transmission of the machine 100 and hoisting of the payload carrier 108 associated with the machine 100.

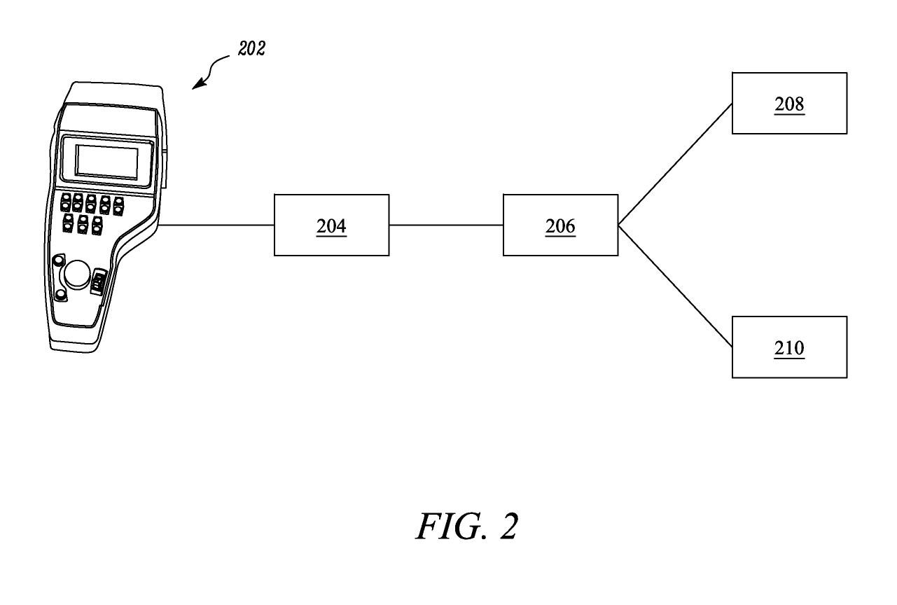

Referring to FIG. 2, in one embodiment, the control panel 202 may be placed in the cab 112. The control panel 202 may further be communicably coupled to an engine control unit (ECU) 204 of the machine 100. Based on an input received from the operator, the control panel 202 may send control signals to the ECU 204, indicative of an operator command for transmission control and/or hoisting control of the machine 100. A person of ordinary skill in the art will appreciate that the ECU 204 may control a variety of functions on the machine 100. For the purpose of this disclosure, we will consider the transmission control of the machine 100 and the hoisting control for the payload carrier 108 of the machine 100.

As shown, the ECU 204 may be coupled to a hydraulics control system 206 of the machine 100. The hydraulics control system 206 is configured to receive inputs from the ECU 204 for controlling a transmission control 208 and/or a hoist control 210 of the machine 100. Hence, the hydraulics control system 206 may effectuate movement of the payload carrier 108 and/or control the transmission of the machine 100 based on control signals received from the ECU 204. The transmission control 208 is configured to set a transmission mode of the machine 100, and perform other related operations such as, shift a gear for a selected transmission mode to control a speed of the machine 100, hold the gear for a desired transmission mode of the machine 100, and the like.

In one embodiment, the transmission mode of the machine 100 may include at least one of a park, reverse, neutral and drive mode. The hoisting control 210 is configured to effectuate hoisting of the payload carrier 108 with respect to the frame 102 of the machine 100, based on inputs provided by the operator via the control panel 202. In another embodiment, the hoisting functions associated with the payload carrier 108 of the machine 100 may include at least one of the lower, hoist, float and raise functions.

The present disclosure relates to the control panel 202 provided within the cab 112 of the machine 100. At least one rotary switch and an input device are disposed on the control panel 202. Any one of the rotary switch and the input device is operable to select from the plurality of transmission modes of the machine 100; while the other of the rotary switch and the input device is operable to select from the plurality of hoisting functions associated with the payload carrier 108 of the machine 100. The input device provided on the control panel 202 may include another rotary switch, a rocker switch, a button, or any other known input device. Additionally, the control panel 202 may also include other components such as push buttons, keypads, display screens, and the like for performing other functions associated with the machine 100.

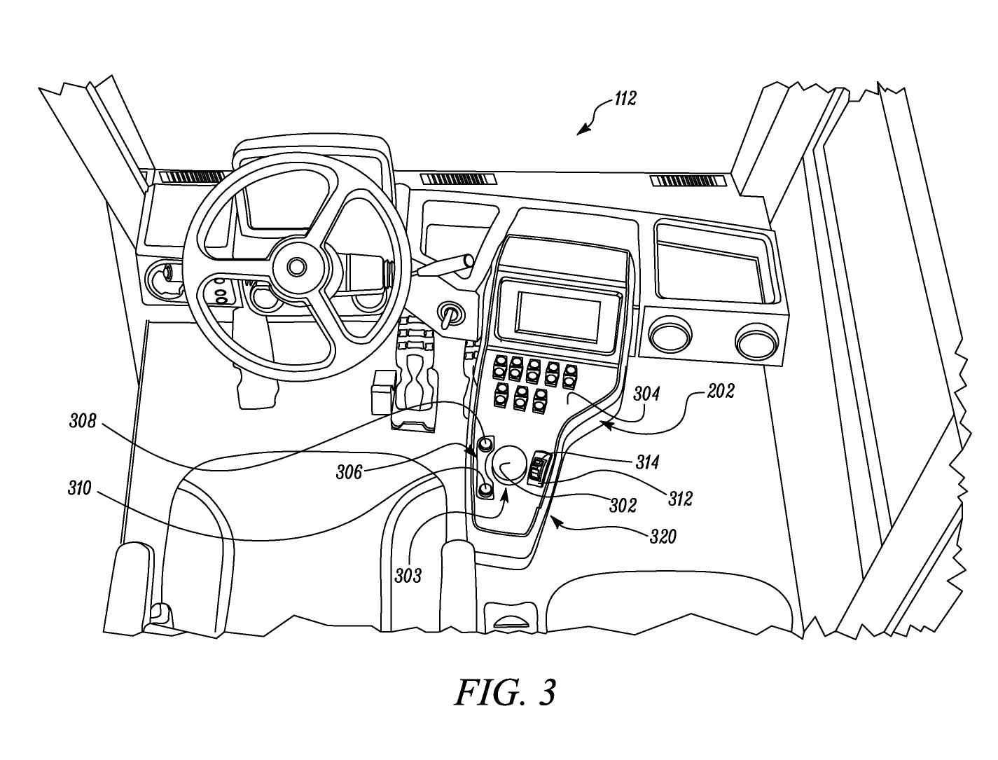

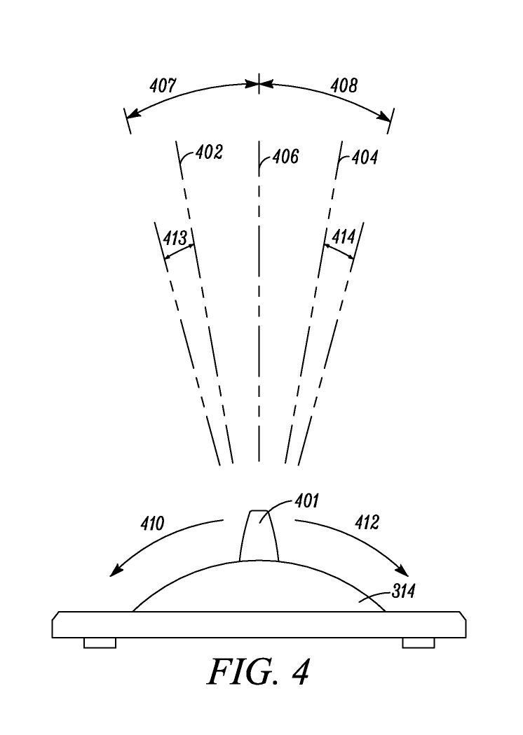

The control panel 202 will now be described in detail in connection with FIGS. 3 and 4. It should be understood that various design implementations may exist for the control panel 202. FIGS. 3 and 4 are two different such designs, according to various embodiments of the present disclosure. One of ordinary skill in the art will appreciate that the designs disclosed herein are exemplary and do not limit the scope of the present disclosure.

FIG. 3 illustrates a perspective view of the cab 112. The control panel 202 includes a rotary switch 302 disposed on an upper surface 304 of the control panel 202 as a transmission input device 303. The rotary switch 302 is operable to select from a plurality of the transmission modes of the machine 100. The transmission modes may include at least one of park, reverse, neutral and drive modes. The rotary switch 302 may be a multi-position switch such that each position may correspond to a particular transmission mode of the machine 100. The operator may easily change from one transmission mode to another by changing the position of the rotary switch 302. Further, the rotary switch 302 may include a detent or locking mechanism known in the art such as, for example, a spring loaded arrangement, in order to hold the selected transmission mode.

As will be understood by a person skilled in the art, the park mode is configured to restrict the movement of the machine 100. For example, during a dump cycle the machine 100 may be in the park mode so that while the dump action is being performed, the machine 100 continues to remain stationary. In the reverse mode, a reverse gear may be engaged to allow the machine 100 to move in the reverse direction. Further, in the neutral mode all gear trains in the transmission control 208 of the machine 100 are disengaged to allow the machine 100 to coast freely under its own weight and gain momentum without the motive force from the engine. Furthermore, in the drive mode, the transmission control 208 of the machine 100 is allowed to engage to the complete range of the available forward gear ratios, to further allow the machine 100 to move forward. The forward mode may allow the operator to accelerate the machine 100 using appropriate gear transmission setting as desired.

In one embodiment, a transmission shift input device 306 may also be provided on the control panel 202. The transmission shift input device 306 may be used to control and shift a gear mechanism of the machine 100. The machine 100 may either include a 3-2-1 system or a 2-1 system. Accordingly, the transmission shift input device 306 may include a transmission upshift device 308. In the illustrated embodiment, the transmission upshift input device 308 is embodied as a button. The transmission upshift input device 308 is operable to upshift the gear of the selected transmission mode.

Also, a transmission downshift input device 310 may be disposed on the control panel 202. The transmission downshift input device 310 may include a button that is operable to downshift the gear of the selected transmission mode. For example, the operator may shift the gear up or down as desired for the selected transmission setting by pressing the respective button. One of ordinary skill in the art will appreciate that the transmission shift input devices 306 may be embodied as push buttons, press buttons, keypads, rotary switches, and the like.

Further, a hoisting input device 312 is disposed on the control panel 202. The hoisting input device 312 is operable to select from a plurality of the hoisting functions associated with the payload carrier 108 of the machine 100. The hoisting functions may include at least one of the raise, lower, hold and float functions. It should be noted that the raising and the lowering functions are associated with the movement of the payload carrier 108 away from or towards the frame 102 of the machine 100 respectively. The hold function is used to retain a current position of the payload carrier 108 between defined limits. The float function is related to holding the payload carrier 108 above a defined limit.

As shown in FIG. 3, the hoisting input device 312 may include a thumb actuated roller switch 314. The roller switch 314 may include detents for enabling the roller switch 314 to be in one of four possible states. A detent is device used to mechanically resist and lock the rotation of the roller switch 312. The detents may define four distinct states of hoisting function. Based on the selected state of the roller switch 314, the payload carrier 108 may be raised, lowered, hold and float. The above described implementation is merely exemplary and does not limit the scope of the present disclosure. The detailed functioning of the roller switch 314 is described in further detail with reference to the following figures.

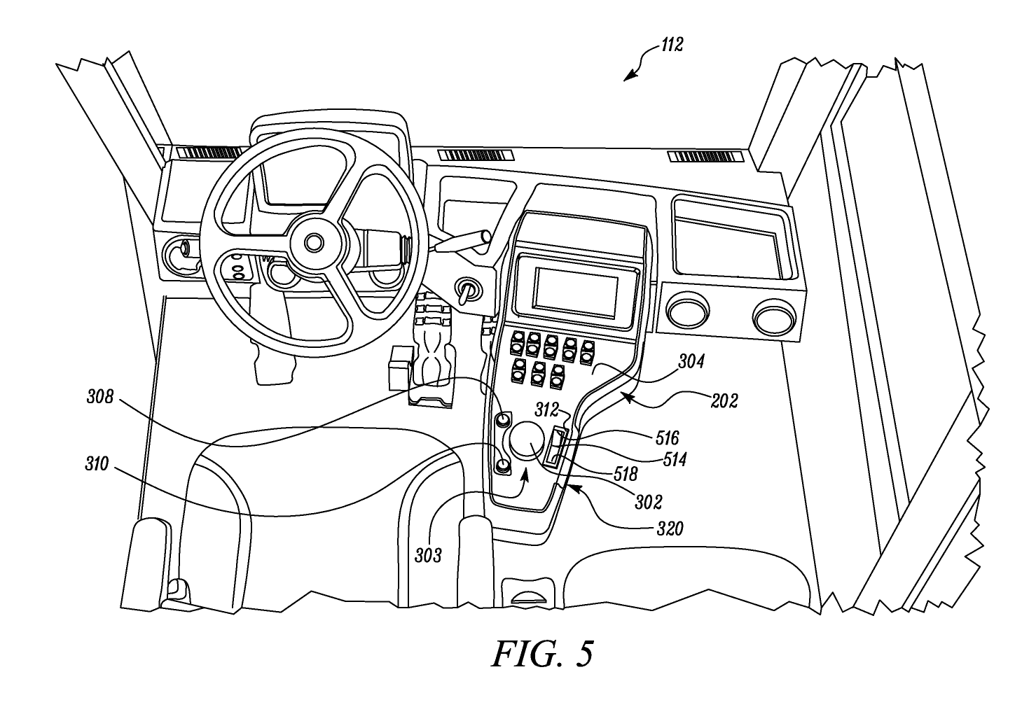

In another embodiment, the hoisting input device 312 may include a thumb actuated rocker switch 514 (as shown in FIG. 5). Based on an actuation force applied by the operator, the rocker switch 514 may be in any one of four possible states. The four states may correspond to the momentary press and continued press applied to any one of the two ends of the rocker switch 514. For example, when a first end 516 of the rocker switch 514 is pressed momentarily, the lower hoisting function may be selected. On continuous press of the first end 516, the float function may be selected. Further, when a second end 518 of the rocker switch 514 is pressed momentarily, the raise function may be selected. Continuous pressing of the second end 518 of the rocker switch 514 may cause the hold function to be selected.

Referring now to FIG. 4, the operation of the roller switch 314 is described in accordance with the embodiments of the present disclosure. In one embodiment, the roller switch 314 may include a protrusion 401 for moving the roller switch 314 to select one of the four functions to be executed. Further, the roller switch 314 may include a first detent 402 and a second detent 404 for providing at least four distinct regions for controlling hoisting functions of the machine 100. In one embodiment, the roller switch 314 may have a steady state position 406 at zero degrees. The steady state position 406 of the roller switch 314 may divide the operational range of the roller switch 314 into two distinct regions, the raising region 407 and the lowering region 408, with each region having one detent point. Therefore, the first detent 402 may provide a detent point in the raising region 407 and the second detent 404 may provide a detent point in the lowering region 408.

In one embodiment, the protrusion 401 may be configured to move and indicate the position of the roller switch 314 within the selected operational region and the selected hoisting function. By default, the protrusion 401 points at the steady state position 406 of the roller switch 314. In one embodiment, the roller switch 314 may be moved in a direction shown by arrow head 410 past the first detent 402 i.e., in a first region 413 to raise the payload carrier 108. Further, when the roller switch 314 is released to move behind the first detent 402, then the payload carrier 108 may be put at a hold position. Furthermore, when the roller switch 314 is moved in a direction shown by arrow head 412 and past the second detent 404, i.e., in a second region 414 then the payload carrier 108 may be lowered. Furthermore, when released to move behind the second detent 404, the payload carrier 108 may float at a position. Although only one detent in each of the raising region 407 and the lowering region 408 has been shown for providing four regions for hoisting control functions of the machine 100, it will be understood by a person skilled in the art that the number of detents and the number of regions may be varied.

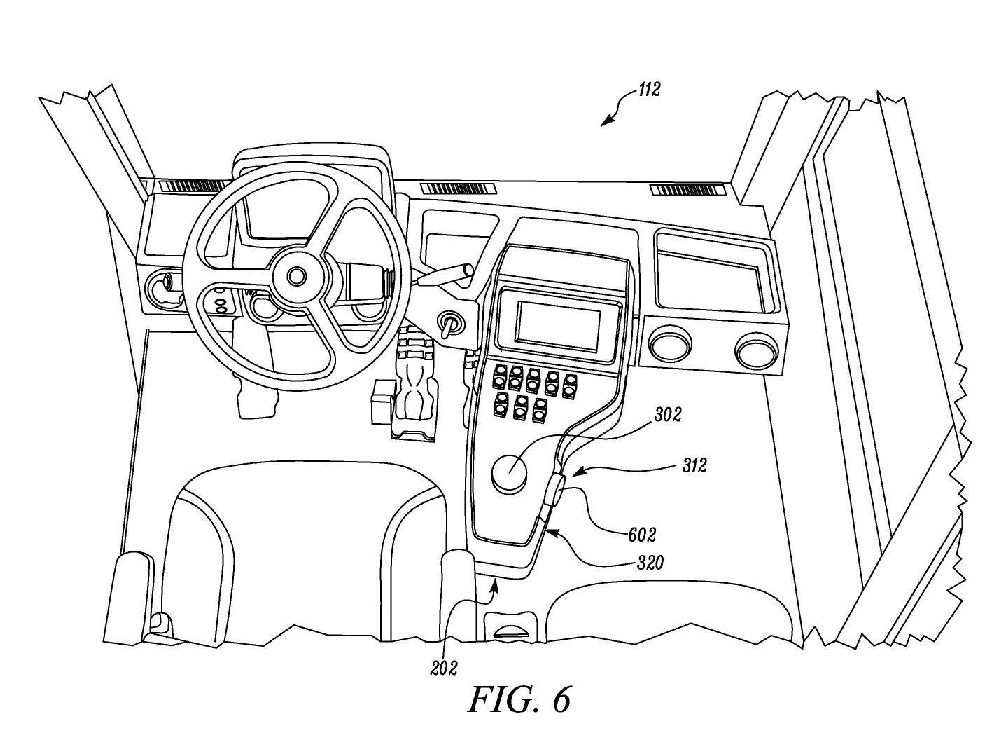

Alternatively, in another design of the control panel 202 shown in FIG. 6, the hoisting input device 312 may be embodied as a rotary switch 602 disposed on a side surface 320 of the control panel 202. The rotary switch 602 may include a multi-position switch, such that based a position of the rotary switch 602 any one of the lower, raise, float and hold hoisting functions may be selected. A different hoisting function may be selected by changing the position of the rotary switch 602. Additionally, the rotary switch 602 may include a detent or locking mechanism known in the art such as, for example, a spring loaded arrangement, in order to hold the selected hoisting function.

As shown in the accompanying figures, the transmission input device 303 and the hoisting input device 312 may be disposed adjacent to one another on any one surface like the upper surface 304 or the side surface 320 of the control panel 202. On the other hand, any one of the transmission input device 303 and the hoisting input device 312 may be placed on one surface of the control panel 202; while the other is placed on a different surface of the control panel 202, as depicted in FIG. 6.

As described above, the control panel 202 may include the rotary switch for either the transmission control 208 or the hoisting control 210, or for both. If used for any one of the controls, the other control may be implemented using another rotary switch (as in FIG. 4) or any other known implementation such as rocker switch, a set of push buttons, and the like. Moreover, the control panel 202 may additionally include other components not described herein.

### INDUSTRIAL APPLICABILITY

Generally, two separate control levers are used to control the transmission settings and the hoisting of the machine respectively. A first lever may allow the operator to set transmission settings and gear transmission settings for the machine; whereas, a second lever may allow the operator to control a plurality of hoisting functions associated with the payload carrier of the machine. This arrangement may cause space constraints within the cab. Further, the operator may face difficulty in simultaneously operating both these functions of the machine.

To this end, the above disclosed control panel 202 enables concurrent controlling of the transmission functions and the hoisting functions of the machine 100, with reduced operator efforts. The control panel 202 provides effective and efficient space utilization within the cab 112 of the vehicle 100. The control panel 202 may be used on a variety of machines having the payload carrier 108. Moreover, the design implementations described herein may be suitably modified as per the need of the application. Additional functionality may be added to the control panel 202 as per requirement.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An input device for a machine, the input device comprising:
a control panel provided within an operator cabin of the machine, the control panel comprising:
a transmission input device disposed on the control panel, the transmission input device operable to select from a plurality of transmission modes of the machine, wherein the transmission input device includes a rotary switch; and
a hoisting input device disposed on the control panel, the hoisting input device operable to select from a plurality of hoisting functions associated with a payload carrier of the machine.

2. The input device of claim 1, wherein the hoisting input device includes one of a thumb actuated rocker switch and a thumb actuated roller switch.

3. The input device of claim 2, wherein the roller switch includes a plurality of detents for selecting a plurality of hoisting functions.

4. The input device of claim 1, wherein the hoisting input device is disposed adjacent to the transmission input device on the control panel.

5. The input device of claim 1 further comprising a transmission shift input device disposed on the control panel, the transmission shift input device operable to shift a gear of the selected transmission mode.

6. The input device of claim 4, wherein the transmission shift input device includes a transmission upshift input device and a transmission downshift input device.

7. The input device of claim 1, wherein the plurality of transmission modes includes at least one of park, reverse, neutral and drive modes.

8. The input device of claim 1, wherein the plurality of hoisting functions includes at least one of lower, float, hold and raise functions.

9. The input device of claim 1, wherein the hoisting input device includes a rotary switch.

10. The input device of claim 1, wherein the transmission input device is disposed on a first surface of the control panel and the hoisting input device is disposed on a second surface of the control panel.

11. An input device for a machine, the input device comprising:
a control panel provided within an operator cabin of the machine, the control panel comprising:
a hoisting input device disposed on the control panel, the hoisting input device operable to select from a plurality of hoisting functions associated with a payload carrier of the machine, wherein the hoisting input device includes a rotary switch; and
a transmission input device disposed on the control panel, the transmission input device operable to select from a plurality of transmission modes of the machine.

12. The input device of claim 11, wherein the transmission input device includes one of a thumb actuated rocker switch and a thumb actuated roller switch.

13. The input device of claim 11, wherein the transmission input device is disposed adjacent to the hoisting input device on the control panel.

14. The input device of claim 11 further comprising a transmission shift input device disposed on the control panel, the transmission shift input device operable to shift a gear of the selected transmission mode.

15. The input device of claim 11, wherein the transmission shift input device includes a transmission upshift input device and a transmission downshift input device.

16. The input device of claim 11, wherein the plurality of transmission modes includes at least one of park, reverse, neutral and drive modes.

17. The input device of claim 11, wherein the plurality of hoisting functions includes at least one of lower, float, hold and raise functions.

18. The input device of claim 11, wherein the transmission input device includes a rotary switch.

19. The input device of claim 11, wherein hoisting input device is disposed on a first surface of the control panel and the transmission input device is disposed on a second surface of the control panel.

20. A machine comprising:
a frame;
a payload carrier pivotally attached to the frame;
an actuator coupled between the frame and the payload carrier, the actuator configured to raise and lower the payload carrier relative to the frame; and
a control panel provided within an operator cabin of the machine, the control panel comprising:
a rotary switch disposed on the control panel;
an input device disposed on the control panel;
wherein one of the rotary switch and the input device is operable to select from a plurality of transmission modes of the machine; and
wherein the other of the rotary switch and the input device is operable to select from a plurality of hoisting functions associated with movement of the actuator to raise and lower the payload carrier relative to the frame of the machine.
